(19) United States
(12) Patent Application Publication
(10) Pub. No.: US 2004/0205416 A1
(43) Pub. Date: Oct. 14, 2004

(54) Communication apparatus with failure detect function

(75) Inventor: Hiroshi Shirota, Hyogo (JP)

Correspondence Address: BURNS, DOANE, SWECKER &, MATHIS, L.L.P, P.O. Box 1404, Alexandria, VA, 22313-1404, US

(73) Assignee: RENESAS TECHNOLOGY CORP

(21) Appl. No.: 10/617,031

(22) Filed: Jul. 11, 2003

(30) Foreign Application Priority Data
Feb. 27, 2003 (JP) 2003-050683(P)

(51) Int. Cl. H02H 3/05

(52) U.S. Cl. 714/48

(57) ABSTRACT

A clock supply select circuit controls supply of receive clock and transmit clock to a receiver and a transmitter. The clock supply select circuit includes a clock generate circuit generating internal clock of the reference, and clock modulate circuit generating a modulate clock signal modulated such that at least one of frequency fluctuation, phase fluctuation, waveform fluctuation and jitter is applied to the internal clock. In a normal operation mode, the internal clock is supplied as receive clock and transmit clock, and in a loopback operation mode, while the internal clock is supplied as receive clock, modulate clock signal is supplied as transmit clock.

### BACKGROUND OF THE INVENTION

1. Field of the Invention

The present invention relates to a communication apparatus, and more specifically, to a failure detect test of a communication apparatus.

2. Description of the Background Art

As the transfer rate is rendered higher in recent various high-speed communication standards, jitter component of transferred data is becoming higher. In communication equipment, circuitry for synchronizing external data to an internal clock, such as CDR (Clock Data Recovery) circuit, elasticity buffer and the like in special, is designed to operate in higher rate in order to address such high-speed data with high jitter. This results in complicated circuitry configuration.

For example, USB 2.0 (Universal Serial Bus Specification Revision 2.0) that is a communication standard of the latest serial interface of de facto standard for connecting a PC (Personal Computer) and peripheral equipment defines the high-speed serial communication of 480 MBPS (Mega-Bits Per Second). An example configuration of a communication apparatus implementing such a communication standard is disclosed, for example, in FIG. 2 of USB 2.0 Transceiver Macrocell Interface (UTMI) Specification Version 1.05, Mar. 29, 2001.

Since these transfer rate (frequency), transmit jitter components and the like are often strictly defined by a standard, a communication apparatus must be thoroughly tested if it meets transfer rate or transmit jitter components required by a high-speed communication standard such as USB 2.0. This requires an expensive test device capable of high-frequency operation that corresponds to the transfer rate, increasing the manufacturing cost of the communication apparatus itself.

Further, Japanese Patent Laying-Open No. 6-311208 discloses, as a general test scheme for a communication apparatus including a receiver and a transmitter, a test scheme by a so-called loopback operation in which a transmit signal output from its own transmitter is received by its own receiver to carry out the test. According to the loopback operation, a failure detect test of a communication apparatus can be carried out inexpensively without expensive external test equipment to see whether it meets transfer rate or transmit jitter components required by a high-speed communication standard.

In a conventional communication apparatus in which its transmitter and its receiver operate synchronizing to the same clock, however, an error detection test of the communication apparatus can not be carried out by the loopback operation under the operating condition that is close to the actual USB communication, where frequency error, transmit jitter, phase fluctuation and waveform fluctuation of clock signal (such as duty ratio) are present. In special, the error detection can not be carried out in effect by the conventional loopback operation for the clock data recovery circuit or the elasticity buffer circuit, which are for absorbing these frequency error, transmit jitter, waveform fluctuation and phase fluctuation to synchronize external data to an internal clock.

Accordingly, there exist a problem that the manufacturing cost of a communication apparatus is increased by an essential test, which uses expensive and high-speed test device that is capable of applying USB data with frequency error, transmit jitter, waveform fluctuation and phase fluctuation.

Further, since a conventional communication apparatus does not include a device for quantitatively measuring jitter components of USB communication data, it has been difficult to carry out an error detection using the loopback operation to see if the waveform quality (jitter components) of the transmitter is within a standard. Therefore, it has been required to perform this error detection using an expensive high-speed tester device, which also contributes to increase the test cost and the manufacturing cost of the communication apparatus.

Still further, for a conventional communication apparatus, it has been necessary to output receive and transmit data of multi-bit and low-speed to the outside of the communication apparatus in the loopback operation. For this purpose, large number of signal input/output paths must be provided, which also contributes to increase the cost of the communication apparatus.

Still further, in a conventional communication apparatus dedicated to half-duplex communication in which the output of the transmitter and the input of the receiver are directly connected, the error detection must be carried out with half-duplex communication even when a plurality of communication apparatuses are involved, and thus the period for the error detection test is increased as compared to a detection test with full-duplex communication. This also contributes to increase the manufacturing cost of the communication apparatus.

### SUMMARY OF THE INVENTION

The present invention is to solve such problems, and an object of the present invention is to provide a communication apparatus capable of performing an error detect test of a receiver and a transmitter through a loopback operation with low test cost, in a communication condition close to the actual operation, in which frequency error, transmit jitter, clock waveform fluctuation or phase fluctuation is added.

Another object of the present invention is to provide a communication apparatus with a configuration capable of checking jitter components (waveform components) of the transmitter through a loopback operation with low test cost, and requiring fewer number of signals to be extracted for the checking.

Still another object of the present invention is to provide a communication apparatus with a configuration capable of performing a high-speed test in a half-duplex scheme communication apparatus.

A communication apparatus according to the present invention includes a transmitter including an encoder circuit for converting transmit data into a transmit signal synchronizing to a transmit clock; a receiver including a decoder circuit for converting a receive signal into receive data synchronizing to a receive clock; and a clock supply select circuit controlling a supply of the transmit clock and the receive clock to the transmitter and the receiver. The clock supply select circuit includes a clock generate circuit generating an internal clock signal, and a clock modulate circuit generating a modulate clock signal that is modulated such that at least one of frequency error, phase fluctuation, jitter and waveform fluctuation is forcibly applied to the internal clock of reference. In a normal operation mode, the clock supply select circuit supplies the internal clock signal as each of the transmit clock and the receive clock in common, and in a loopback operation mode, the clock supply select circuit supplies the internal clock signal as one of the transmit clock and the receive clock and supplies the modulate clock signal as the other of the transmit clock and the receive clock.

A communication apparatus according to another configuration of the present invention includes a transmitter including an encoder circuit converting transmit data into a transmit signal synchronizing to a clock signal; a receiver including a decoder circuit converting a receive signal into receive data synchronizing to the clock signal; a clock generate circuit generating a plurality of clock signals having the same frequency as the clock signal and with phases different from each other; and a jitter measure circuit measuring, in a loopback operation mode, jitter occurring in the transmitter, based on a transition of a result of phase comparison between a transition edge of the receive signal and a transition edge of the plurality of clock signals.

A communication apparatus according to still another configuration of the present invention includes a communication node and a test communication node capable of transmitting and receiving a signal between another communication apparatus; a transmitter converting received transmit data into a transmit signal and outputting it to the communication node; a receiver converting a receive signal that is received at a receive node and outputting the converted receive signal as receive data; and a signal switch selectively forming a signal path between one of the communication node and the test communication node, and the receive node. In a first test mode, a signal path is formed between the communication node as well as the test communication node of the communication apparatus, and the communication node as well as the test communication node of the another communication apparatus, respectively. Within each of the communication apparatus and the another communication apparatus, the signal switch forms a signal path between the test communication node and the receive node.

Accordingly, the main advantage of the present invention is that the communication apparatus is capable of operating one of a receiver and a transmitter synchronizing to an internal clock, while operating the other one of the receiver and the transmitter synchronizing to a modulate clock signal that is modulated such that at least one of frequency error, phase fluctuation, waveform fluctuation and jitter is forcibly applied to the internal clock. Therefore, an error detect test of the receiver and transmitter can be carried out through a loopback operation without using a high-speed and expensive test apparatus, under a condition close to the actual operating mode.

By including a jitter measure circuit, the error in waveform quality of the transmitter, i.e., jitter error can be detected through the loopback operation in which the receiver and the transmitter are synchronized to a common clock, without using high-speed and expensive test device for extracting large number of signals.

Further, by arranging a signal switch that is capable of selectively forming a signal path between one of a communication node and a test communication node in a half-duplex communication apparatus, a high-speed failure detect test can be carried out in a full-duplex mode by connecting two of such communication apparatuses to each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an overall configuration example of a communication apparatus according to a first embodiment of the present invention;

FIG. 2 is a block diagram showing a configuration example of an encoder circuit shown in FIG. 1;

FIG. 3 is a block diagram showing a configuration example of a decoder circuit shown in FIG. 1;

FIG. 4 is a block diagram showing a configuration example of a clock modulate circuit shown in FIG. 1;

FIG. 5 is a waveform diagram illustrating an internal clock group;

FIG. 6 is a block diagram showing a configuration example of a data compare circuit shown in FIG. 1;

FIG. 7 is a block diagram showing a configuration example of a jitter measure circuit shown in FIG. 1;

FIG. 8 is a circuit diagram showing a configuration example of a clock sampler shown in FIG. 7;

FIG. 9 is a diagram for describing an operation example of the clock sampler shown in FIG. 8;

FIG. 10 is a flowchart describing an operation example of a phase compare circuit shown in FIG. 7;

FIG. 11 is a block diagram showing an overall configuration example of a communication apparatus according to a second embodiment of the present invention; and

FIG. 12 indicates signal paths between communication apparatuses in a test mode according to a third embodiment.

### DESCRIPTION OF THE PREFERRED EMBODIMENTS

In the following, embodiments of the present invention will be described in detail referring to the figures. Throughout the figures, an identical reference character indicates identical or corresponding parts.

### First Embodiment

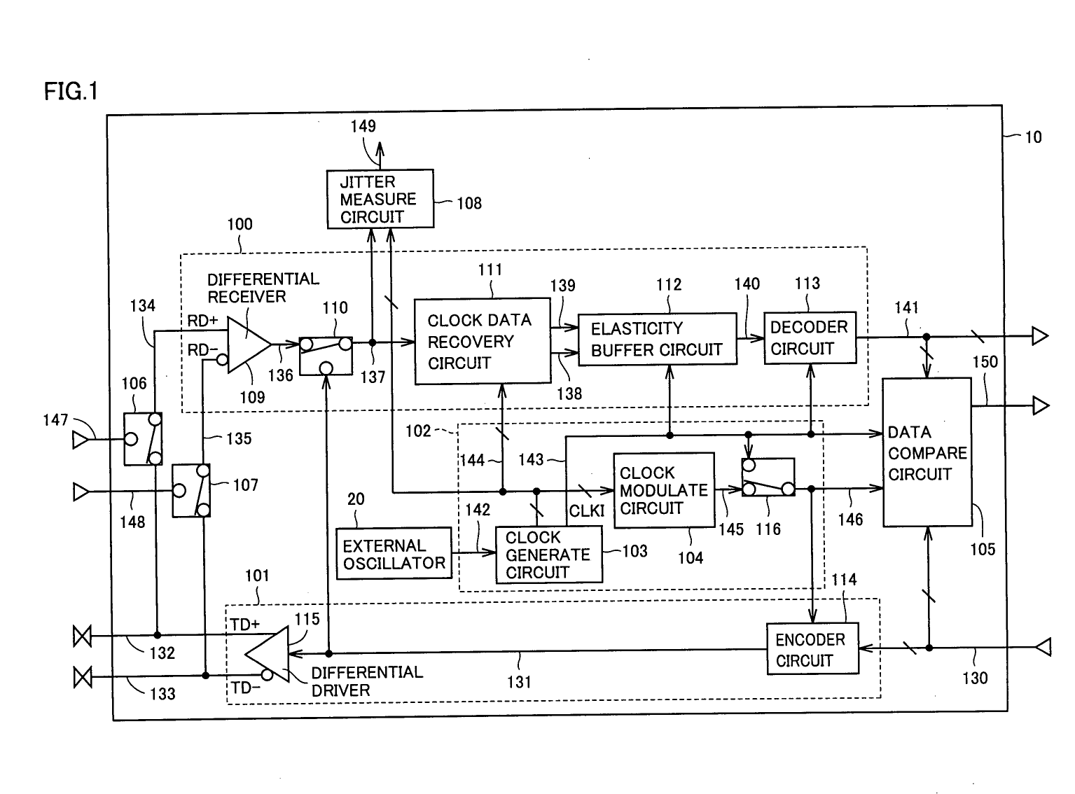

Referring to FIG. 1, a communication apparatus 10 according to the first embodiment of the present invention is a communication apparatus implementing a physical layer (PHY layer) of USB 2.0 Hi-speed (480 MBPS).

Referring to FIG. 1, communication apparatus 10 includes a receiver 100, a transmitter 101, a clock supply select circuit 102, a data compare circuit 105, signal switches 106, 107, and a jitter measure circuit 108.

Clock supply select circuit 102 has a clock generate circuit 103, a clock modulate circuit 104, and a clock switch 116.

Clock generate circuit 103 multiplies an external clock 142 from an external oscillator 20 to generate an internal clock signal CLKI and an internal clock group 144. Internal clock signal CLKI and internal clock group 144 are high-speed clocks with a frequency of 480 MHz. For example, if the frequency of external clock 142 is 12 MHz, then clock generate circuit 103 multiplies external clock 142 by a factor of 40. By setting the multiplying factor of clock generate circuit 103 appropriately, the frequency of external clock 142 can be set arbitrarily, not being limited to 12 MHz as above.

Clock supply select circuit 102 transmits internal clock signal CLKI as a receive clock 143 to receiver 100 and data compare circuit 103. Internal clock group 144 includes a plurality of clock signals of which phases are different from each other at the frequency of 480 MHz. In the following, though it is assumed in the present embodiment that internal clock group 144 is formed by ten clock signals 144-0 to 144-9 with stepwise phase differences among them as will be described below, the number of clock signals forming internal clock group 144 is not specifically limited and any arbitrary number can be employed.

Clock modulate circuit 104 selectively outputs one of the clock signals among internal clock group 144 received from clock generate circuit 103 to generate a modulate clock signal 145. Modulate clock signal 145 is modulated such that at least one of frequency error, phase fluctuation, clock waveform fluctuation (such as duty ratio) and jitter is forcibly applied to internal clock signal CLKI of the reference, that has been transmitted to receiver 100 (i.e., receive clock 143).

Clock switch 116 is provided corresponding to transmitter 101 for selectively supplying one of receive clock 143 (internal clock signal CLKI) and modulate clock signal 145 as a transmit clock 146 to data compare circuit 105 and encoder circuit 114 in transmitter 101.

Transmitter 101 includes encoder circuit 114 that converts transmit data 130 into a transmit signal 131 through a signal processing defined by a prescribed communication standard, and a differential driver 115. In communication apparatus 10 shown in FIG. 1, 8-bit parallel transmit data 130 is converted into transmit signal 131 of a high-speed serial signal by encoder circuit 114.

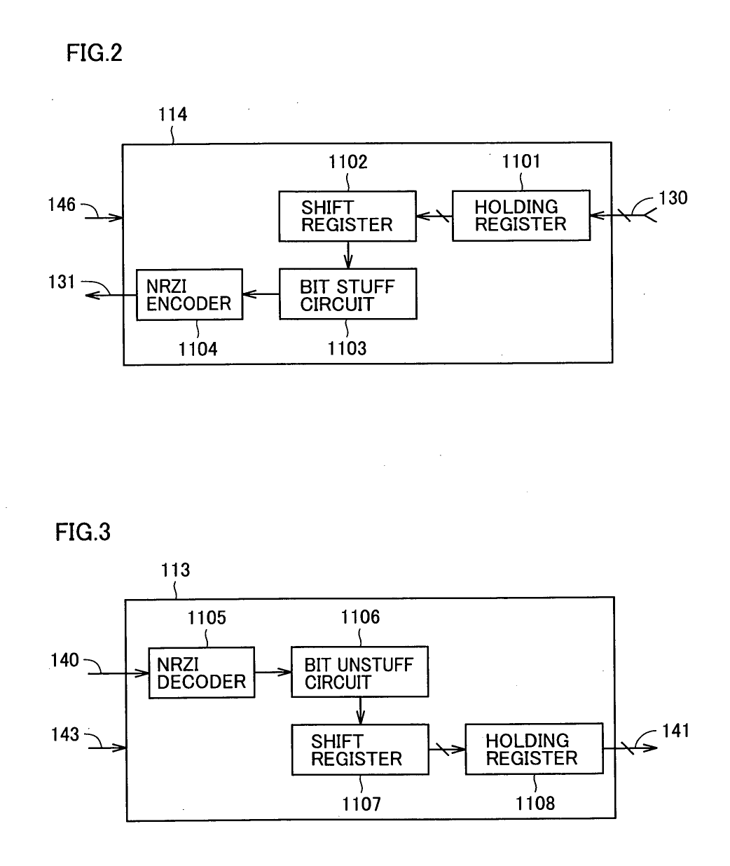

Referring to FIG. 2, encoder circuit 114 converts 8-bit parallel transmit data 130 into a 1-bit serial signal by a parallel-serial convert circuit, which is formed with a holding register 1101 and a shift register 1102. A bit stuff circuit 1103 and an NRZI (Non Return to Zero Invert) encoder 1104 encodes the converted serial signal into a serial data compliant to USB standard to generate a single-end serial transmit signal 131. In the following, though in the present embodiment a serial interface communication that handles a serial signal is described in detail as a representative example, the number of signals is not specifically limited and any arbitrary number can be employed.

Referring back to FIG. 1, differential driver 115 receives single-end transmit signal 131 generated by encoder circuit 114 and convert it into transmit differential signals TD+ and TD− of + side and − side. Transmit differential signals TD+ and TD− are output to communication nodes 132 and 133, respectively. In the following, though in the present embodiment a differential communication including differential driver 115 is described in detail as a representative example, the application of the present invention is not limited to the differential communication using a differential signal, and it is applicable to a single-end communication as well.

Signal switch 106 selectively forms a signal path between either one of communication node 132 or test communication node 147 and receive node 134. Similarly, signal switch 107 selectively forms a signal path between either one of communication node 133 or test communication node 148 and receive node 135. The signal switches are typically implemented by a mechanical or an electrical switch for switching an electrical connection between signal lines.

In each of a normal operation mode performing a half-duplex communication and a loopback operation mode, signal switches 106 and 107 form signal paths between communication nodes 132, 133, and receive nodes 134, 135, respectively.

Signal switches 106 and 107 form signal paths between test communication nodes 147, 148 and receive nodes 134, 135, respectively, in another test mode (full-duplex test operation) other than the loopback operation, which will be described in the following third embodiment. As will be described in detail later, in this another test mode, test communication nodes 147 and 148 each receive a transmit differential signal from another communication apparatus.

Therefore, in the normal operation mode, transmit differential signals that have been input to communication nodes 132, 133 from a transmitter in another communication apparatus are transmitted to receive nodes 134, 135 as receive differential signals RD+, RD−. On the other hand, in the loopback operation, transmit differential signals TD+, TD− generated by the communication apparatus's own transmitter are transmitted to receive nodes 134, 135 as receive differential signals RD+, RD−. In the following, though a serial interface communication is described where transmit differential signals TD+, TD− and receive differential signals RD+, RD− form a pair, respectively, as mentioned above, the application of the present invention is not limited to such a one-pair serial interface standard.

Receiver 100 includes a differential receiver 109, a signal switch 110, a clock data recovery circuit 111, elasticity buffer circuit 112, and decoder circuit 113.

Differential receiver 109 converts receive differential signals RD+, RD− transmitted to receive nodes 134, 135 into a single-end serial signal 136. Signal switch 110 selectively outputs one of serial signal 136 output from differential receiver 109 and transmit signal 131 output from encoder circuit 114 as a receive signal 137.

Clock data recovery circuit 111 extracts clock and data from receive signal 137 to generate a recovery clock 138 and recovery data 139.

Elasticity buffer circuit 112 is provided as a timing difference buffer circuit between recovery clock 138 and receive clock 143, and generates a synchronous data signal 140 synchronized to receive clock 143 from recovery clock 138 and recovery data 139 in FIFO (First In First Out) scheme. Decoder circuit 113 converts synchronous data signal 140 into an 8-bit parallel receive data 141.

Referring to FIG. 3, decoder circuit 113 includes an NRZI decoder 1105, a bit unstuff circuit 1106, a shift register 1107, and a holding register 1108.

NRZI decoder 1105 and bit unstuff circuit 1106 decode synchronous data signal 140 of a serial signal into serial data. Further, thus decoded serial data is converted into 8-bit parallel receive data 141 by a serial-parallel convert circuit formed by shift register 1107 and holding register 1108.

Referring back to FIG. 1, in the loopback operation, jitter measure circuit 108 receives transmit signal 131, which has been transmitted as receive signal 137 by signal switch 110, and internal clock group 144 to evaluate the waveform quality (jitter components) of transmitter 101.

Data compare circuit 105 compares transmit data 130 input to transmitter 101 and receive data 141 output from receiver 100 to generate a data mismatch detect signal 150 that indicates the comparison result.

Next, the loopback operation of communication apparatus 10 shown in FIG. 1 is described.

The loopback operation of the communication apparatus according to the present invention includes first and second loopback tests. In the first loopback test, the failure detect test of receiver 100 or transmitter 101 is carried out with at least one of jitter, frequency error, clock waveform fluctuation and phase fluctuation is forcibly applied to one of the receive clock and transmit clock. On the other hand, in the second loopback test, the failure detection test for evaluating the waveform quality (jitter components) of transmitter 101 is carried out setting the receive clock and transmit clock to a common clock.

As described above, in each of the first and second loopback tests, signal switches 106 and 107 form signal paths between communication nodes 132, 133 and receive nodes 134, 135, respectively. Thus, transmit differential signals TD+, TD− generated by transmitter 101 are transmitted to receive nodes 134, 135 as receive differential signals RD+, RD−, respectively.

Further, signal switch 110 forms a signal path for transmitting serial signal 136 output from differential receiver 109 to subsequent circuitry as receive signal 137.

Now, the first loopback test is described. In the first loopback test in communication apparatus 10 according to the first embodiment, at least one of jitter, frequency error, waveform fluctuation and phase fluctuation is forcibly applied to transmit clock 146 for transmitter 101. In other words, clock switch 116 selects modulate clock signal 145 output from clock modulate circuit 104 and supplies it as transmit clock 146 to encoder circuit 114 and data compare circuit 105.

Clock modulate circuit 104 selects one of a plurality of clock signals forming internal clock group 144 and with different phases from each other, and outputs as modulate clock signal 145. Clock modulate circuit 104, of which detailed configuration will be described later, can control the phase of modulate clock signal 145 through a selection of a clock signal with a specific phase from internal clock group 144. Further, phase, frequency, clock waveform (such as duty ratio) and jitter of modulate clock signal 145 can be changed by switching the selection from internal clock group 144 automatically, or by switching it dynamically or statically by an external control.

For example, by switching the selection of clock signal so that the phase thereof lags sequentially, the frequency of modulate clock signal 145 can be set lower than the frequency of internal clock signal CLKI of the reference (480 MHz). By switching the selection of clock signal so that the phase thereof advances sequentially, the frequency of modulate clock signal 145 can be set higher than the reference frequency (480 MHz).

The frequency of modulate clock signal 145 can be controlled by the frequency of switching the selection from internal clock group 144. Further, since the level transition edge of the clock changes at the moment of switching the selection of clock, the amount of jitter, which is the change in the position of the level transition edge, can be controlled. The jitter amount can be controlled by the frequency of switching the selection of internal clock group 144 and by the phase difference between clock signals prior to and subsequent to the selection switching.

As above, modulate clock signal 145 generated by clock modulate circuit 104 is modulated such that at least one of frequency error, phase fluctuation, waveform fluctuation and jitter is forcibly applied to internal clock signal CLKI (i.e., receive clock 143) of the reference.

In transmitter 101, encoder circuit 114 generates a serial transmit signal 131 (480 MHz) from 8-bit parallel transmit data 130 (60 MHz) synchronizing to transmit clock 146. Since at least one of frequency error, phase fluctuation, clock waveform fluctuation and jitter is applied to transmit clock 146 by clock modulate circuit 104, at least one of frequency error, phase fluctuation, waveform fluctuation and jitter is applied as well to transmit signal 131 that is synchronized to transmit clock 146, in comparison with internal clock signal CLKI of the reference (receive clock 143).

After being converted into transmit differential signals TD+, TD− (480 MHz) by differential driver 115, transmit signal 131 is input to receiver 100 as receive differential signals RD+, RD− via signal switches 106 and 107. As a result, at least one of frequency error, phase fluctuation, waveform fluctuation and jitter is applied to transmit differential signals TD+, TD− and receive differential signals RD+, RD− of 480 MHz, similar to transmit signal 131.

As described above, at receiver 100, receive differential signals RD+, RD− are converted into single-end serial signal 136 by differential receiver 109, which is then input to clock data recovery circuit 111 as receive signal 137 via signal switch 110.

As for recovery clock 138 and recovery data 139, which are generated by clock data recovery circuit 111 recovering clock and data from receive signal 137, since receive signal 137 includes at least one of frequency error, phase fluctuation, waveform fluctuation and jitter, recovery clock 138 changes dynamically as well. As a result, receiver 100 can be operated in a state close to the actual communication mode by dynamically operating clock data recovery circuit 111.

Conversely, in the loopback operation in a conventional communication apparatus, since a transmitter and a receiver operate synchronizing to a common clock signal, receive signal 137 does not include any of frequency error, phase fluctuation, waveform fluctuation nor jitter. Accordingly, since the phase of recovery clock 138 is fixed as well, the operating ratio of clock data recovery circuit 111 is lowered and receiver 100 can not be operated in a state close to the actual communication mode.

Elasticity buffer circuit 112 absorbs the frequency error between receive clock 143 and recovery clock 138 that has been recovered by clock data recovery circuit 111 to generate serial synchronous data signal 140 synchronized to receive clock 143. Synchronous data signal 140 is converted to 8-bit parallel receive data 141 by decoder circuit 113.

Data compare circuit 105 generates data mismatch detect signal 150 in accordance with the result of matching comparison between transmit data 130 input in transmitter and receive data 141 output from receiver 100. Since transmit data 130 and receive data 141 do not match if an error is present in receiver 100, the value of data mismatch detect signal 150 is set to the level indicating mismatching. On the other hand, when an error is not present in receiver 100, data mismatch detect signal 150 is set to the level indicating transmit data 130 and receive data 141 are matched. Therefore, it is possible to determine externally whether receiver 100 functions normally by taking out 1-bit data mismatch detect signal 150.

Thus, in the first loopback test, while receiver 100 is operated synchronizing to internal clock signal CLKI of the reference, transmitter 101 is operated synchronizing to modulate clock signal 145. As a result, through loopback operation without using high-speed and expensive test device, the error detect test of receiver 100 can be carried out in a state close to the actual operating mode by operating clock data recovery circuit 111 and elasticity buffer circuit 112 under various conditions.

Next, the second loopback test is described. In the second loopback test, clock switch 116 selects a clock signal common to receive clock 143, i.e., internal clock signal CLKI, and supplies it to encoder circuit 114 and data compare circuit 105 as transmit clock 146. As a result, internal clock signal CLKI of the reference, which is 480 MHz and not being modulated, is supplied to both of receiver 100 and transmitter 101.

Thus, transmitter 101 generates transmit signal 131 and transmit differential signals TD+, TD−, synchronizing to internal clock signal CLKI not being modulated. Transmit differential signals TD+, TD− are input to receiver 100 via signal switches 106 and 107.

Similarly to the first loopback test mentioned above, serial signal 136 obtained at differential receiver 109 is transmitted as receive signal 137 to receiver 100.

Jitter measure circuit 108 detects the transition amount of the difference between each edge of ten clock signals with different phases that forms internal clock group 144, and the edge of receive signal 137 as jitter. Specifically, when thus obtained transition amount of the difference exceeds a prescribed level, jitter error detect signal 149 is set to a prescribed level.

By including such a jitter measure circuit 108, the error in waveform quality of transmitter 101, i.e., jitter error can be detected based on the output of 1-bit jitter error detect signal 149 through the loopback operation in which receiver 100 and transmitter 101 are synchronized to a common clock and without using high speed and expensive test device.

Further, receive signal 137 is converted to 8-bit parallel receive data 141 by clock data recovery circuit 111, elasticity buffer circuit 112 and decoder circuit 113. Therefore, in the second loopback test also, it is possible to detect the error of transmitter 101 or receiver 100 by comparing receive data 141 obtained at receiver 100 and transmit data 130 input to transmitter 101 by data compare circuit 105.

In either of the first or second loopback tests described above, signal switch 110 can be set to form a signal path for transmitting serial transmit signal 131 from encoder circuit 114 to receiver 100 directly as receive signal 137.

In this case, the first and second loopback test can be carried out bypassing differential driver 115 and differential receiver 109. Thus, if an error is detected by a loopback test not bypassing differential driver 115 and differential receiver 109, while no error is detected by a loopback test through a path bypassing differential driver 115 and differential receiver 109, then it can be determined that an error is present in differential driver 115 or differential receiver 109. Hence, since whether a failure is present in differential receiver 109 or differential driver 115 can be determined easily, the location of the error can be specified easily.

Next, the configuration of main circuits in communication apparatus 10 shown in FIG. 1 is described in detail.

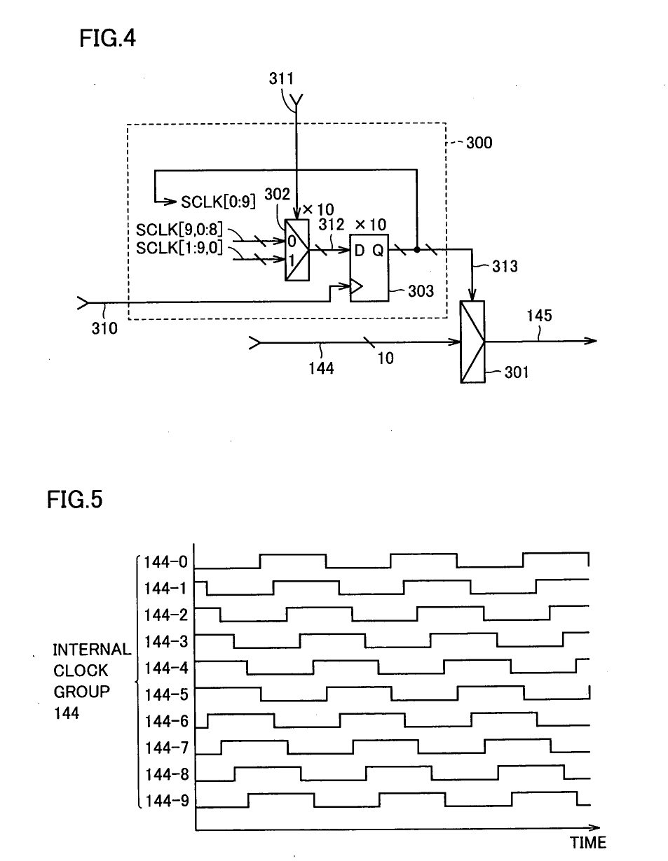

Referring to FIG. 4, clock modulate circuit 104 includes a ring counter 300 that is a 10-bit up/down counter, and a selector circuit 301.

Ring counter 300 has at least one selector 302 and at least one flip-flop 303. The numbers of selector 302 and flip-flop 303 are the same with the number of clock signals forming internal clock group 144, i.e., ten each.

FIG. 5 is a waveform diagram of internal clock group 144.

Referring to FIG. 5, as described above, internal clock group 144 is formed by ten clock signals 144-0 to 144-9 of which phases are different from each other and which are of the same frequency (480 MHz). As for clock signals 144-0 to 144-9, the phase difference between clock signals adjacent to each other is evenly 1/10 cycle. Specifically, the phase of clock signal 144-n (n: an integer between 0-9) lags behind that of clock signal 144-(n−1) by 1/10 cycle. Additionally, the phase of clock signal 144-0 lags behind that of clock signal 144-9 by 1/10 cycle.

Referring back to FIG. 4, selector 302 corresponding to clock signal 144-0 receives SCLK(9) and SCLK(1) among SCLK[0:9] (referring generally to SCLK(0)-SCLK(9); hereinafter similar expression may be used for a signal with a plurality of bits) that indicates count value, and selectively outputs either of the two that corresponds to up/down identify signal 311. Then, the bit of SCLK[0:9] that is input to each selector 302 shifts by one bit. For example, SCLK(0) and SCLK(2) are input to selector 302 that corresponds to clock signal 144-1, and SCLK(8) and SCLK(0) are input to selector 302 that corresponds to clock signal 144-9.

Flip-flop 303 that corresponds to n-th (hereinafter also referred to as “n-th phase”) clock signal, in response to the transition edge of count clock 310 that is the external trigger defining the count timing of ring counter 300, takes in the output of corresponding selector 302 and outputs as SCLK(n). Note that count clock 310 may have a regular cycle or an irregular cycle.

As a result, SCLK[0:9] is provided to selector circuit 301 as clock select signal 313 of 10-bit and 1-hot code, in which only one bit is set to the different level from others (e.g., “1”).

When up/down identify signal 311 is “0”, SCLK[0:9] is counted down in response to count clock 310, thus changing from the state SCLK(n)=“1” to the state SCLK(n−1)=“1”. Note that it changes from the state SCLK(0)=“1” to the state SCLK(9)=“1”.

On the other hand, when up/down identify signal 311 is “1”, SCLK[0:9] is counted up in response to count clock 310, thus changing from the state SCLK(n)=“1” to the state SCLK(n+1)=“1”. Note that it changes from the state SCLK(9)=“1” to the state SCLK(0)=“1”.

Selector circuit 301 selects one of the ten clock signals 144-0 to 144-9 forming internal clock group 144 in accordance with clock select signal 313 and outputs it as modulate clock signal 145. For example, if SCLK(0)=“1” in clock select signal 313, then 0th phase clock signal 144-0 is selected from clock signals 144-0 to 144-9.

Therefore, when up/down identify signal 311 is “0”, the clock signal selected by selector circuit 301 is shifted from n-th phase clock signal 144-n to (n−1)-th phase clock signal 144-(n−1), synchronizing to the rising edge of count clock 310. Note that when n=0, it is shifted from clock signal 144-0 to clock signal 144-9. As a result, the phase of modulate clock signal 145 is advanced gradually and the frequency thereof rises. Further, since the edge of modulate clock signal 145 is shifted for each rising edge of count clock 310, jitter can forcibly be generated.

Conversely, when up/down identify signal 311 is “1”, the clock signal selected by selector circuit 301 is shifted from n-th phase clock signal 144-n to (n+1)-th phase clock signal 144-(n+1), synchronizing to the rising edge of count clock 310. Note that when n=9, it is shifted from clock signal 144-9 to clock signal 144-0. As a result, the phase of modulate clock signal 145 lags gradually and the frequency thereof falls. Further, since the edge of modulate clock signal 145 is shifted for each rising edge of count clock 310, jitter may forcibly be generated.

Thus, modulate clock signal 145 generated by clock modulate circuit 104 can be modulated such that at least one of frequency error, phase fluctuation and jitter is forcibly applied to internal clock signal CLKI of the reference.

Next, the configuration of the data compare circuit used in the first loopback test is described.

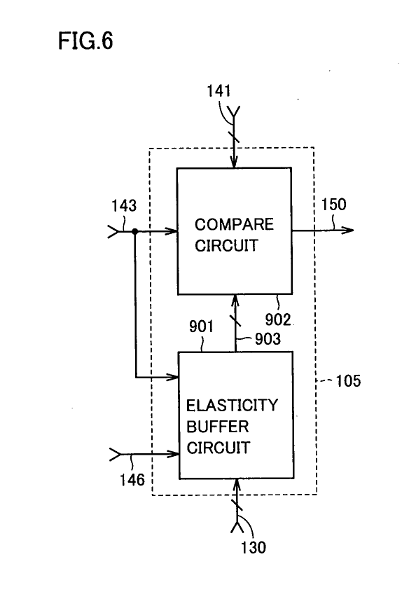

Referring to FIG. 6, data compare circuit 105 includes elasticity buffer circuit 901 and compare circuit 902. Elasticity buffer circuit 901 receives 8-bit parallel transmit data 130 that is input to transmitter, receive clock 143 and transmit clock 146. As described above, transmit clock 146 is applied with modulate clock signal 145 generated by clock modulate circuit 104, and receive clock 143 corresponds to internal clock signal CLKI of the reference.

Elasticity buffer circuit 901 has the similar function as elasticity buffer circuit 112 as shown in FIG. 1, and provided as a buffer circuit for absorbing the clock timing difference between receive clock 143 (internal clock signal CLKI) and transmit clock 146 (modulate clock signal 145). Specifically, elasticity buffer circuit 901 receives transmit data 130 and retains it by the timing difference between transmit data 130 and receive data 141, and then outputs it as a signal 903. As a result, signal 903 is synchronized with receive data 141 output from receiver 100.

Compare circuit 902 generates data mismatch detect signal 150 in response to the result of matching comparison between signal 903 from elasticity buffer circuit 901 and receive data 141 from receiver 100.

Thus, while supplying internal clock signal CLKI of the reference as receive clock 143 to receiver 100, matching comparison can be performed on transmitter 101 by synchronizing the transmit data input to the transmitter and the receive data obtained from the receiver in the loopback operation that supplied modulate clock signal 145 (the first loopback test).

Next, the configuration of the jitter measure circuit used in the second loopback test is described.

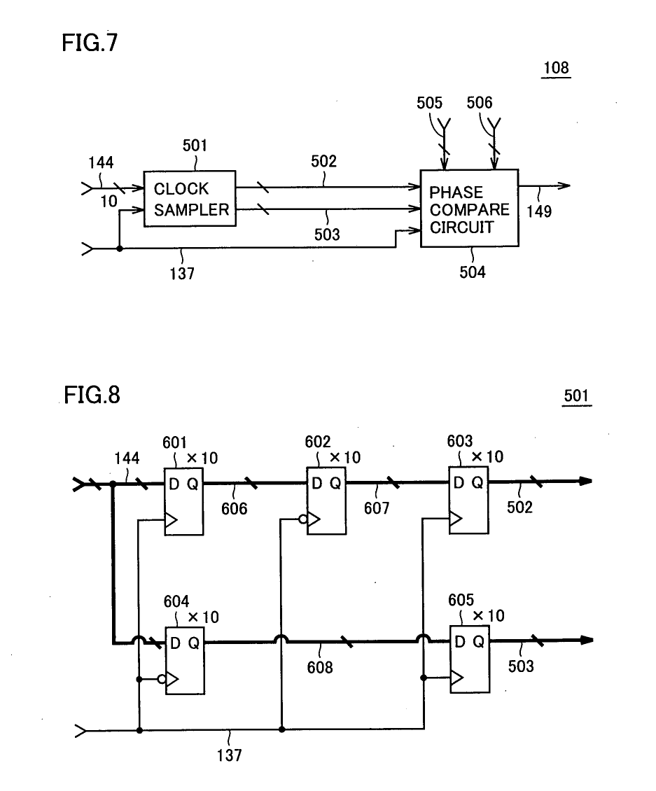

Referring to FIG. 7, jitter measure circuit 108 shown in FIG. 1 has a clock sampler 501 and phase compare circuit 504. Clock sampler 501 samples ten clock signals that form internal clock group 144 at the timing corresponding to serial receive signal 137. As described above, in the loopback operation mode, serial signal 137, which is a receive signal, is in response to transmit signal 131 output from the communication apparatus's own transmitter 101.

Clock sampler 501 outputs positive edge position information 502 based on information sampled at the positive edge (rising edge) of serial signal 137 and negative edge position information 503 based on information sampled at the negative edge (falling edge). Specifically, positive edge position information 502 indicates between which phases of ten clock signals 144-0 to 144-9 forming internal clock group 144 the positive edge of serial signal 137 is positioned. Specifically, positive edge position information 502 indicates the phase of the positive edge of serial signal 137.

Similarly, negative edge position information 503 indicates between which phases of ten clock signals 144-0 to 144-9 forming internal clock group 144 the negative edge of serial signal 137 is positioned. Specifically, negative edge position information 503 indicates the phase of the negative edge of serial signal 137.

Phase compare circuit 504 receives initiation signal 505 instructing the initiation of phase compare operation, a signal 506 indicating jitter tolerance value, positive edge position information 502 and negative edge position information 503 from clock sampler 501. Phase compare circuit 504 detects the difference between positive edge position information 502 and negative edge position information 503. When this difference is larger than the defined value indicated by signal 506, it is determined that the jitter tolerance is exceeded, and jitter error detection signal 149 is set to an enable state.

Referring to FIG. 8, clock sampler 501 shown in FIG. 7 includes flip-flop circuits 601-605. Each of flip-flop circuits 601-605 generally refers to flip-flops that are provided ten each corresponding to ten clock signals 144-0 to 144-9 forming internal clock group 144.

In response to the positive edge of serial signal 137, flip-flop circuit 601 outputs a 10-bit signal 606 by sampling the level of each of ten clock signals 144-0 to 144-9 forming internal clock group 144. Similarly, in response to the negative edge of serial signal 137, flip-flop circuit 604 outputs a 10-bit signal 608 by sampling the level of each of clock signals 144-0 to 144-9. In response to the negative edge of serial signal 137, flip-flop circuit 602 outputs a 10-bit signal 607 by sampling 10-bit signal 606 output from flip-flop circuit 601.

In response to the positive edge of serial signal 137, flip-flop circuit 603 outputs a 10-bit signal as positive edge position information 502 by sampling 10-bit signal 607 output from flip-flop circuit 602. In response to the positive edge of serial signal 137, flip-flop circuit 605 outputs a 10-bit signal as negative edge position information 503 by sampling 10-bit signal 608 output from flip-flop circuit 604.

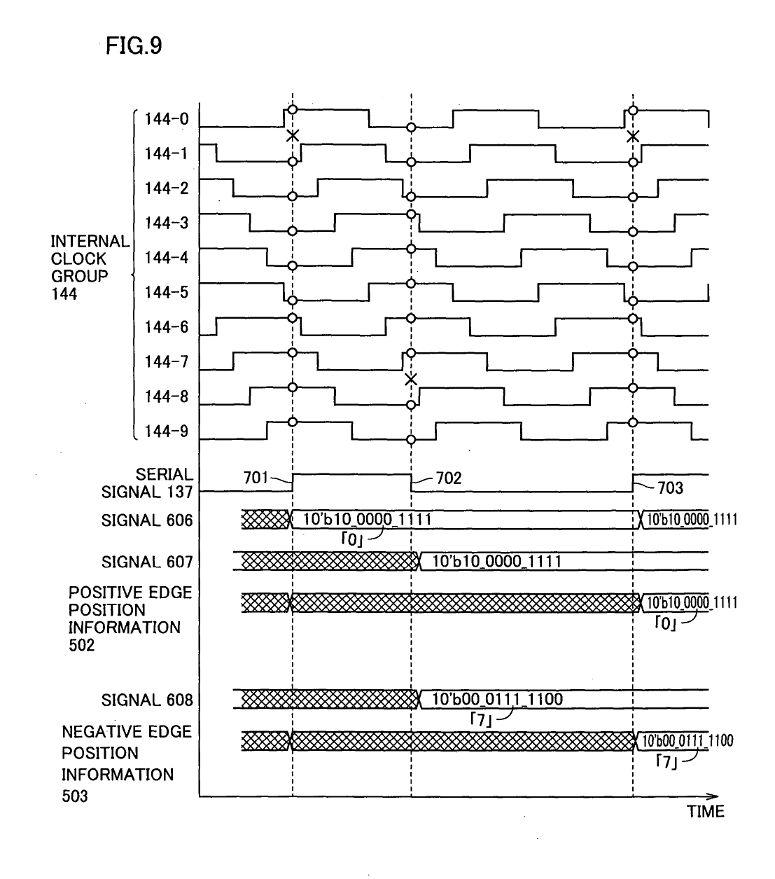

FIG. 9 is a diagram for describing the operation example of the clock sampler circuit.

In response to positive edge 701 of serial signal 137, the level of each of clock signals 144-0 to 144-9 forming internal clock group 144 is sampled and signal 606 is set to “10′b10_{—}0000_{—}1111”. Specifically, the data sampled between 0th bit and first bit is changed from “1” to “0”. This bit position in which the value is changed from 1 to 0 indicates the phase of positive edge 701. In this case, it is indicated that the edge of serial signal 137 is present between the positive edges of clock signals 144-0 and 144-1.

Here, the phase range between the positive edges of clock signals 144-0 and 144-1 is referred to as the 0th phase range, and the value of signal 606 is assumed to be “0”. In the similar manner, from the first phase range to the ninth phase range are present, and from “1” to “9” values of signal 606 are present. This signal 606 is sampled again at flip-flop circuits 602 and 603 and converted into a signal synchronized to positive edge 703 of serial signal 137 to be positive edge position information 502. Specifically, the values of positive edge position information 502 are present from “0” to “9” corresponding to the number of clock signals forming internal clock group 144. In the example of FIG. 9, positive edge position information 502 is “10′b10_{—}0000_{—}1111”, and the value is “0”.

Similarly, a signal 608 can be obtained by sampling internal clock group 144 by flip-flop circuit 603 synchronizing to negative edge 702 of serial signal 137. Signal 608 will be “10′b00_{—}0111_{—}1100”. In this signal 608, the value changes from 1 to 0 between the seventh bit and the eighth bit, indicating that negative edge 702 is present between clock signals 144-7 and 144-8, i.e., in the seventh phase region. Thus, the value of signal 608 at the level of “10′b00_{—}0111_{—}1100” is assumed to be “7”.

Being sampled again at flip-flop circuit 603, signal 608 is converted into negative edge position information 503. As a result, negative edge position information 503 will be “10′b00_{—}0111_{—}1100”, hence the value is “7”.

Next, the operation of phase compare circuit 504 that receives these positive edge position information 502 and negative edge position information 503.

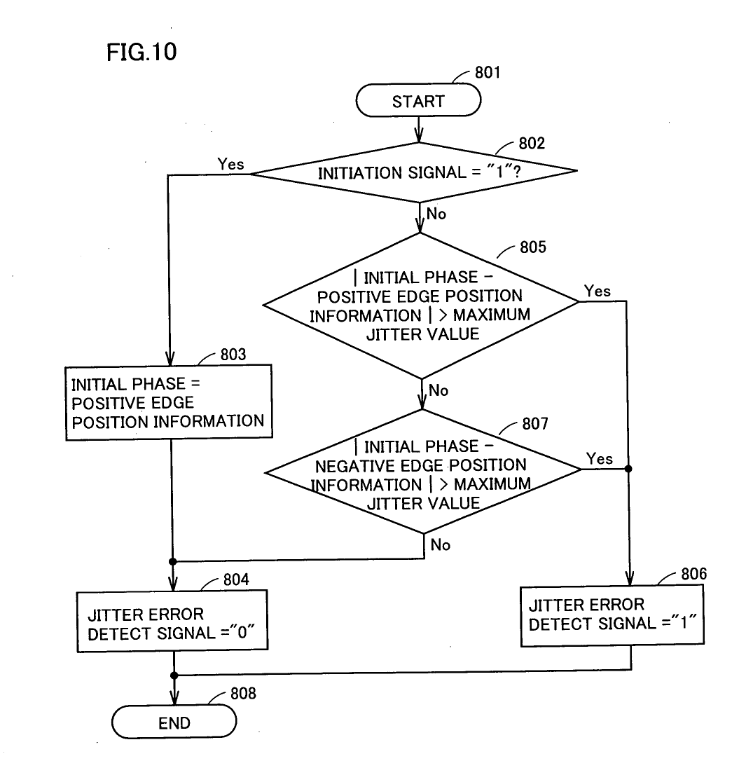

FIG. 10 is a flowchart describing the operation example of phase compare circuit 504. Phase compare circuit 504 performs the operation indicated in the flowchart of FIG. 10 at every positive edge of serial signal 137.

Referring to FIG. 10, when a phase compare operation is started (step 801), the value of initiation signal 505 applied to phase compare circuit 504 is checked, and the initiation of phase comparison is determined if the value of initiation signal 505 is “1” (step 802). When the initiation of phase comparison is determined, as the initial value of phase comparison, current positive edge position information 502 is stored in a register or the like to be the initial phase (step 803). At this stage, since no error is detected, the value of jitter error detect signal 149 is “0”, i.e., no error (step 804).

If the value of initiation signal 505 is “0” at step 802 and the phase comparison has been initiated already, the magnitude of the difference between the value of positive edge position information 502 obtained at the positive edge and the value of the initial phase stored in a register or the like at step 803 is calculated as the phase difference (step 805). When this difference (phase difference) is larger than the maximum jitter value (tolerable value) indicated by signal 506, the jitter error detect signal is set to “1” (step 806). When the magnitude of the difference between the value of the initial phase and the value of positive edge position information 502 is smaller than the maximum jitter value, the magnitude of the difference between the value of current negative edge position information 503 and the value of the initial phase is calculated as the phase difference. This difference (phase difference) is compared to the maximum jitter value to determine which is larger (step 807).

In step 807, when the difference between the value of the initial phase and the value of current negative edge position information 503 is smaller than the tolerable value, it is determined that jitter error is not present, and the value of jitter error detect signal is set to “0” (step 804). Thus, when the transition amount of positive edge position information 502 from the initial phase and that of negative edge position information 503 from the initial phase are both smaller than the maximum jitter value (tolerable value), “no jitter error” is determined. Otherwise, “jitter error present” is determined, and the phase compare operation ends (step 808).

Thus, through the loopback operation in which receiver 100 and transmitter 101 are operated synchronizing to a common clock (the second loopback test), the error of the waveform quality of transmitter 101, i.e., jitter error can be detected based on the output of 1-bit jitter error detect signal 149, without using high-speed and expensive test device.

As above, according to the communication apparatus according to the first embodiment of the present invention, through at least one of the first and second loopback tests, the error detect test of the receiver and the transmitter can be carried out and waveform quality of the transmitter (jitter components) can be evaluated in a state close to the actual operation mode, without using a high-speed and expensive test device for extracting large number of signals.

### Second Embodiment

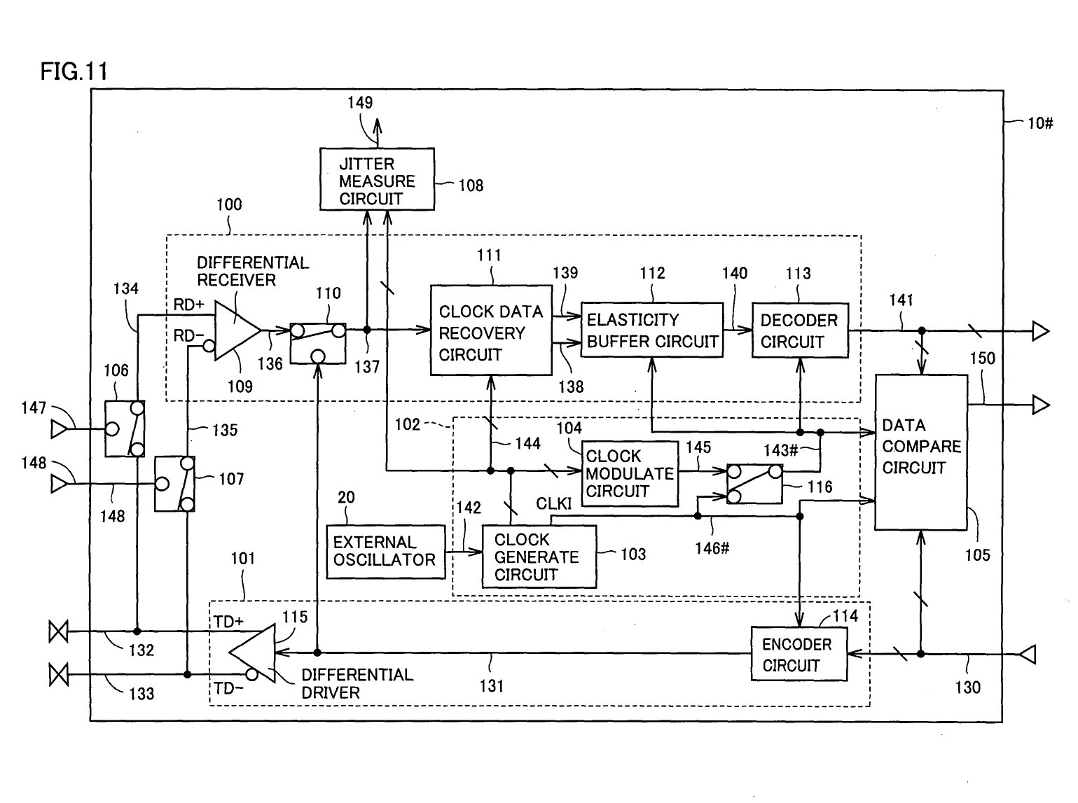

Referring to FIG. 11, a communication apparatus 10# according to a second embodiment of the present invention is different from communication apparatus 10 according to the first embodiment shown in FIG. 1 in the configuration of clock supply select circuit 102. Specifically, in communication apparatus 10# according to the second embodiment, internal clock signal CLKI (480 MHz) of the reference is supplied to transmitter 101 directly as transmit clock 136#, while clock switch 116 is provided corresponding to receiver 100.

Clock switch 116 selectively supplies one of internal clock signal CLKI used as transmit clock 146# and modulate clock signal 145 output from clock modulate circuit 104 to receiver 100 as receive clock 143#. The rest of the configuration of communication apparatus 10# is similar to that of communication apparatus 10 according to the first embodiment, thus detailed description thereof is not repeated.

By employing such a configuration, in the configuration according to the second embodiment, frequency error, phase fluctuation, waveform fluctuation and jitter will not be applied to transmit signal 131 and transmit differential signals TD+, TD− generated by transmitter 101. Receiver 100 receives transmit differential signals TD+, TD− or transmit signal 131 without frequency error, phase fluctuation, waveform fluctuation and jitter as receive signal 137.

However, since elasticity buffer circuit 112 and decoder circuit 113, which are for converting receive signal 137 to receive data 141, operate synchronizing to modulate clock signal 145, through the first loopback test similar to the first embodiment, the error detect test of the receiver and the transmitter can be carried out by the loopback operation without using high-speed and expensive test device, with at least one of frequency error, phase fluctuation, waveform fluctuation and jitter is applied, i.e., in a state similar to the actual operation.

Further, by changing the setting of clock switch 116, the second loopback test similar to the first embodiment can be carried out as well. Specifically, by including the jitter measure circuit, an error in the waveform quality of the transmitter, i.e., jitter error can be detected without using fast-speed and expensive test device for extracting large number of signals.

### Third Embodiment

In a third embodiment, a test mode for carrying out a high-speed failure detect test is described, in which half-duplex communication apparatus 10 or 10# described in the first or second embodiment is operated in a full-duplex manner.

In the test mode according the third embodiment, in communication apparatuses 10 and 10# shown in FIGS. 1 and 11, respectively, signal switches 106 and 107 form signal paths between test communication nodes 147, 148, and receive nodes 134, 135, respectively. Specifically, inside communication apparatuses 10, 10#, the signal paths between their communication nodes 312, 133 and receive nodes 134, 135 are disconnected.

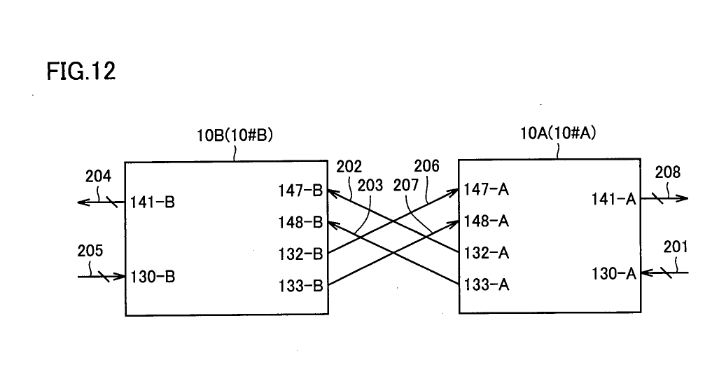

FIG. 12 shows the signal paths between the communication apparatuses in the test mode according to the third embodiment.

Referring to FIG. 12, in the test mode according to the third embodiment, a signal is transmitted and received between two communication apparatuses 10A and 10B. Communication apparatus 10A receives transmit data 201 as transmit data 130-A at transmitter 101 and convert it into a transmit differential signal, and outputs it from communication nodes 132-A, 133-A. Similarly, communication apparatus 10B receives transmit data 205 as transmit data 130-B at transmitter 101 and convert it into a transmit differential signal, and outputs it from communication nodes 132-B, 133-B.

Further, signal paths are formed between communication nodes 132-A, 133-A of communication apparatus 10A, and test communication nodes 147-B, 148-B of communication apparatus 10B, respectively. Similarly, signal paths are formed between communication nodes 132-B, 133-B of communication apparatus 10B, and test communication nodes 147-A, 148-A of communication apparatus 10A, respectively.

Accordingly, each of communication apparatuses 10A and 10B accepts a transmit signal input to test communication nodes 147, 148 from the other communication apparatus as a receive signal via signal switches 106 and 107.

By performing a failure detect test by forming such signal paths, receiver 100 of communication apparatus 10A receives a transmit signal generated by transmitter 101 of communication apparatus 10B to generate receive data 208 (141-A). Similarly, receiver 100 of communication apparatus 10B receives a transmit signal generated by transmitter 101 of communication apparatus 10A to generate receive data 204 (141-B).

Accordingly, through the comparison of transmit data 201 input to communication apparatus 10A and receive data 204 output from communication apparatus 10B, as well as the comparison of transmit data 205 input to communication apparatus 10B and receive data 208 output from communication apparatus 10A, errors in communication apparatuses 10A and 10B can be detected simultaneously. In other words, the test for error detection in a communication apparatus can be carried out at the doubled speed. Further, if a communication apparatus that is confirmed to have no error beforehand is applied for one of communication apparatuses 10A and 10B, an error in the other communication apparatus can be detected at high speed.

It should be noted that, the test mode according to the third embodiment can be carried out by the combination of communication apparatuses 10#A and 10#B according to the second embodiment. Alternatively, it is possible to carry out the test mode according to the third embodiment by the combination of communication apparatus 10 according to the first embodiment and communication apparatus 10# according to the second embodiment.

Further, in the test mode according to the third embodiment, the manner of supplying a receive clock and a transmit clock within communication devices 10, 10# may be the same as the first or second loopback operation mode, so as to meet the purpose of a failure detect test.

As above, in the test mode according to the third embodiment, by employing half-duplex communication apparatuses in each of which a signal switch is arranged that is capable of selectively forming a signal path between either one of communication node or test communication node and receive node, and connecting two of such communication apparatuses to each other, a high-speed failure detect test can be carried out in a full-duplex condition.

Additionally, as described in the first and second embodiments, by forming signal paths between communication nodes 132, 133 and receive nodes 134, 135 by signal switches 106, 107 in communication apparatuses, respectively, the first or second loopback test can be carried out as BIST (Built In Self Test).

As above, though in the first to third embodiments of the present invention the configuration examples of communication apparatus compliant to USB 2.0 have been described, the application of the present invention is not limited to such cases. In other words, the present invention is applicable to a communication apparatus that is compliant to any of “IEEE (Institute of Electrical and Electronic Engineers) 1394”, “PCI (Peripheral Component Interconnect) Express”, “Serial ATA”, “LVDS (Low Voltage Differential Signaling)”, “Rapid IO” and any other serial interface standards, or parallel interface standards such as “ATA” (AT Attachment).

Further, as for the operating frequency of the communication apparatus and the number of transmit/receive data bits also, they are not limited to 480 MHz and 8-bit width, and the present invention can be applied in accordance with any other condition.

Still further, though in the first to third embodiments of the present invention a communication apparatus including a receiver formed with a differential receiver, a clock data recovery circuit, an elasticity buffer circuit and a decoder circuit has been described, the present invention is applicable to a communication apparatus including a receiver of other scheme such as an over-sampling scheme.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication apparatus, comprising:
a transmitter including an encoder circuit for converting transmit data into a transmit signal synchronizing to a transmit clock;
a receiver including a decoder circuit for converting a receive signal into receive data synchronizing to a receive clock; and
a clock supply select circuit controlling a supply of said transmit clock and said receive clock to said transmitter and said receiver,
said clock supply select circuit including
a clock generate circuit generating an internal clock signal, and
a clock modulate circuit generating a modulate clock signal that is modulated such that at least one of frequency error, phase fluctuation, jitter and waveform fluctuation is forcibly applied to said internal clock of reference, wherein
in a normal operation mode, said clock supply select circuit supplies said internal clock signal as each of said transmit clock and said receive clock in common, and in a loopback operation mode, said clock supply select circuit supplies said internal clock signal as one of said transmit clock and said receive clock and supplies said modulate clock signal as the other of said transmit clock and said receive clock.

2. The communication apparatus according to claim 1, wherein
said clock supply select circuit includes a clock switch provided corresponding to said transmitter, wherein
said clock switch supplies to said transmitter, in said normal operation mode, said internal clock signal as said transmit clock, and in said loopback operation mode, said modulate clock signal as said transmit clock, and wherein
said clock supply select circuit supplies to said receiver, in each of said normal operation mode and said loopback operation mode, said internal clock signal as said receive clock.

3. The communication apparatus according to claim 1, wherein
said clock supply select circuit includes a clock switch provided corresponding to said receiver, wherein
said clock switch supplies to said receiver, in said normal operation mode, said internal clock signal as said receive clock, and in said loopback operation mode, said modulate clock signal as said receive clock, and wherein
said clock supply select circuit supplies to said transmitter, in each of said normal operation mode and said loopback operation mode, said internal clock signal as said transmit clock.

4. The communication apparatus according to claim 1, wherein
said clock generate circuit further generates a plurality of clock signals having a same frequency as said internal clock signal and with phases different from each other, and wherein
said clock modulate circuit includes
a counter circuit of which count value changes synchronizing to an external trigger, and
a selector circuit receiving said plurality of clock signals from said clock generate circuit and selectively outputting one of said plurality of clock signals that corresponds to said count value as said modulate clock signal.

5. The communication apparatus according to claim 1, further comprising
a data compare circuit comparing said transmit data input to said encoder circuit and said receive data output from said decoder circuit, and generating a signal in accordance with a result of the comparison.

6. The communication apparatus according to claim 5, wherein
said data compare circuit includes
a buffer circuit receiving said transmit data, retaining said transmit data inside for a period in accordance with a timing difference between said internal clock signal and said modulate clock signal, and outputting said transmit data, and
a comparator comparing said transmit data output from said buffer circuit and said receive data from said decoder circuit.

7. The communication apparatus according to claim 1, wherein
said transmitter further includes a differential driver converting said transmit signal of a single-end signal into a differential signal to be output, and wherein
said receiver further includes a differential receiver converting a received differential signal into said receive signal of a single-end signal;
said communication apparatus further comprising
a signal switch forming as necessary, in said loopback operation mode, a signal path bypassing said differential driver and said differential receiver for passing said transmit signal output from said encoder circuit directly as said receive signal.

8. A communication apparatus, comprising:
a transmitter including an encoder circuit converting transmit data into a transmit signal synchronizing to said clock signal;
a receiver including a decoder circuit converting a receive signal into receive data synchronizing to said clock signal;
a clock generate circuit generating a plurality of clock signals having a same frequency as said clock signal and with phases different from each other; and
a jitter measure circuit measuring, in a loopback operation mode, jitter occurring in said transmitter, based on a transition of a result of phase comparison between a transition edge of said receive signal and a transition edge of each of said plurality of clock signals.

9. The communication apparatus according to claim 8, wherein
said jitter measure circuit includes
a clock sampling circuit detecting each level of said plurality of clocks at each of said transition edges of said receive signal, and
a phase compare circuit converting a transition of the level of said plurality of clocks between each of said transition edges of said receive signal, detected by said clock sampling circuit, into a phase difference.

10. The communication apparatus according to claim 9, wherein
said phase compare circuit generates a detect signal indicating whether said phase difference obtained by converting the transition of the level of said plurality of clocks exceeds a prescribed jitter tolerance value.

11. The communication apparatus according to claim 8, wherein
said transmitter further includes a differential driver converting said transmit signal of a single-end signal into a differential signal to be output, and wherein
said receiver further includes a differential receiver converting a received differential signal into said receive signal of a single-end signal;
said communication apparatus further comprising
a signal switch forming as necessary, in said loopback operation mode, a signal path bypassing said differential driver and said differential receiver for passing said transmit signal output from said encoder circuit directly as said receive signal.

12. A communication apparatus, comprising:
a communication node and a test communication node capable of transmitting and receiving a signal between other said communication apparatus;
a transmitter converting received transmit data into a transmit signal and outputting it to said communication node;
a receiver converting a receive signal that is received at a receive node and outputting the converted receive signal as receive data; and
a signal switch selectively forming a signal path between one of said communication node and said test communication node, and said receive node; wherein
in a first test mode, a signal path is formed between said communication node of said communication apparatus and said test communication node of said other communication apparatus, as well as between said test communication node of said communication apparatus and said communication node of said other communication apparatus, and wherein
within each of said communication apparatus and said other communication apparatus, said signal switch forms a signal path between said test communication node and said receive node.

13. The communication apparatus according to claim 12, wherein
in each of a second test mode that is different from said first test mode and a normal operation mode, said signal switch of said communication apparatus forms a signal path between said communication node and said receive node of said communication apparatus.

14. The communication apparatus according to claim 12, wherein
said transmitter and said receiver operates synchronizing to a transmit clock and a receive clock, respectively;
said communication apparatus further comprising
a clock supply select circuit controlling a supply of said transmit clock and said receive clock to said transmitter and said receiver; wherein
said clock supply select circuit includes
a clock generate circuit generating an internal clock signal, and
a clock modulate circuit generating a modulate clock signal that is modulated such that at least one of frequency error, phase fluctuation, jitter and waveform fluctuation is applied to said internal clock signal of reference, and wherein
in said normal operation mode, said clock supply select circuit supplying said internal clock signal as each of said transmit clock and said receive clock in common, and in said first test mode, said clock supply select circuit supplying said internal clock signal as one of said transmit clock and said receive clock, and said modulate clock signal as the other of said transmit clock and said receive clock.

15. The communication apparatus according to claim 12, wherein
said transmitter includes an encoder circuit converting said transmit data into said transmit signal synchronizing to a clock signal, and wherein
said receiver includes a decoder circuit converting said receive signal into said receive data synchronizing to said clock signal;
said communication apparatus further comprising
a clock generate circuit generating a plurality of clock signals having a same frequency as said clock signal and with phases different from each other, and
a jitter measure circuit measuring, in said first test mode, jitter occurring in said transmitter based on a transition of a result of phase comparison between a transition edge of said receive signal and a transition edge of said plurality of clock signals.
